(19) United States
(12) Patent Application Publication
(10) Pub. No.: US 2010/0308723 A1
(43) Pub. Date: Dec. 9, 2010

(54) ELECTRODE FOR A HIGH-PRESSURE DISCHARGE LAMP, AND METHOD FOR THE PRODUCTION THEREOF

(75) Inventors: Thomas Degenhard, Berlin (DE); Juergen Kellerer, Berlin (DE); Matthias Lenz, Falkensee (DE); Sascha Piltz, Berlin (DE); Dieter Trypke, Falkensee (DE); Karen Twesten, Berlin (DE); Oliver Apel, Berlin (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/809,074

(22) PCT Filed: Nov. 18, 2008
(86) PCT No.: PCT/EP2008/065742

§ 371 Date: Jun. 18, 2010

(30) Foreign Application Priority Data
Dec. 20, 2007 (DE) 102007061514.2

(51) Int. Cl. H01J 61/073; H01J 9/02

(52) U.S. Cl. 313/631; 445/49

(57) ABSTRACT

An electrode for a high-pressure discharge lamp, cut out in one piece from a rod or pin is provided. The electrode may include an electrode head as first segment; and a shaft as second segment, wherein the electrode has an asymmetrical shape which has been produced by means of a sublimation laser.

### TECHNICAL FIELD

The invention is based on an electrode for a high-pressure discharge lamp in accordance with the precharacterizing clause of claim 1. Such electrodes are suitable in particular for high-pressure discharge lamps with a ceramic discharge vessel.

### PRIOR ART

WO 2005/062343 has disclosed an electrode for a high-pressure discharge lamp in which a sublimation laser is used for producing a bore in the head of the electrode.

### DESCRIPTION OF THE INVENTION

The object of the present invention is to provide an electrode for a high-pressure discharge lamp which has an optimized asymmetrical shape. A further object of the present invention is to specify a method which makes it possible to produce electrodes for high-pressure discharge lamps with a complex shape in a simple and inexpensive manner.

This object is achieved by the characterizing features of claim 1 and claim 5, respectively.

Particularly advantageous configurations are given in the respective dependent claims.

The invention now proposes an electrode which is manufactured from a tungsten material or another material which is highly thermally resistant such as TaC and which has an optimized asymmetrical shape.

Specifically, the invention concerns an electrode for a high-pressure discharge lamp, cut out in one piece from a rod or pin, with an electrode head as first segment and a shaft as second segment, wherein the electrode has an asymmetrical shape which has been produced by means of a sublimation laser.

In particular, it is thus possible to produce a head which is configured in the form of a dome, with side wall faces of the head having been removed.

Another embodiment is that a segment of a sphere has been removed parallel to the longitudinal axis of the shaft, the cutting edge of the segment of the sphere in particular coinciding with an extension of a shaft edge.

In particular, the head can be shaped in the form of an ellipsoid or paraboloid. The transition between the head and the shaft can additionally have an undercut.

In a preferred embodiment, the shaft of the electrode has been provided with longitudinally parallel grooves in pillar fashion.

The invention also relates to a discharge vessel for a high-pressure discharge lamp with at least one electrode as described above.

A preferred application of these electrodes is in a discharge vessel which is manufactured from a ceramic material, in particular Al₂O₃, and is sealed at one end. Such discharge vessels are used in particular in high-pressure discharge lamps, in particular with a metal halide fill.

Furthermore, the invention also relates to a method for producing an electrode by means of a laser with the following steps:
providing a cylindrical rod or pin consisting of a high-melting material, in particular tungsten, alloys with tungsten or TaC;
making one end of the rod into a sphere by means of laser bombardment;
subsequent processing of the solid integral electrode produced in this way by means of a sublimation laser.

Shapes of the electrode will be explained in more detail below.

Such a shape is, for example, a dome-like head which has a notch, or a dome-like head which has a circumferential transverse slot. In particular, the shaft of the electrode can also have a complex configuration, in particular be provided with longitudinal flutes in pillar fashion. A further preferred shape is a head which has a mushroom-like cap.

A first aspect of the invention is a method for producing such complex shapes. Essential for this purpose is the use of a sublimation laser for shaping the electrode. This is intended to mean in particular a laser which has a high radiation density which is at least sufficient for sublimating tungsten.

The high radiation density must be sufficient for bringing the electrode material from the solid state directly into the gaseous state during processing and shaping. This may be an Nd:YAG laser or CO2 laser with a sufficiently high power. A preferred aspect is that it provides sufficiently short pulses of at most 1 μs in duration and produces the required energy density for sublimating at least tungsten. A typical repetition rate is from 5 to 50 kHz.

This electrode is particularly well suited for metal halide fills which are accommodated in ceramic discharge vessels. Such discharge vessels are used for metal halide lamps.

### BRIEF DESCRIPTION OF THE DRAWINGS

The invention will be explained in more detail below with reference to a plurality of exemplary embodiments. The figures show:

FIGS. 1-9 an electrode for a high-pressure discharge lamp with different embodiments;

FIG. 10 shows a high-pressure discharge lamp with such an electrode.

### PREFERRED EMBODIMENT OF THE INVENTION

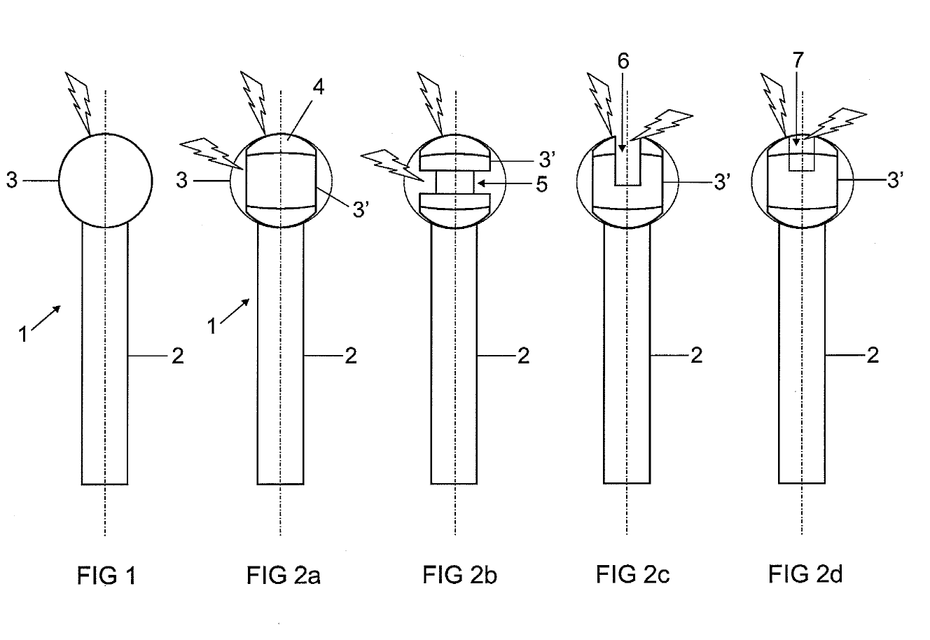

An exemplary embodiment of an electrode 1 is shown in FIG. 1. It has a cylindrical shaft 2 and a spherical head 3. The spherical head is rounded off by it being shaped into a sphere by means of a high-power Nd:YAG laser (lightning symbol). The electrode is manufactured in one piece from tungsten.

A further exemplary embodiment of an electrode 1 is shown in FIG. 2. Therein, FIG. 2a shows a solid integral electrode 1 consisting of tungsten which has been produced originally as a spherical-head electrode as in FIG. 1. However, it is processed further still by a special sublimation laser making the symmetrical spherical head 3 narrower in the manner of a dome at the two sides parallel to the shaft, with the result that lateral wall pieces are removed. A dome 3′ remains. The discharge-side surface 4 can also be set to a specific curvature using the sublimation laser.

In FIG. 2b, the electrode described in FIG. 2a is processed still further. In this case, a circumferential flute 5 is produced by a sublimation laser in the center of the dome 3′ transversely with respect to the axis of the shaft.

In FIG. 2c, the electrode described in FIG. 2a is processed further by a slot 6 being produced with a sublimation laser at the tip of the dome 3′.

In FIG. 2d, the electrode described in FIG. 2a is processed further by a bore 7 being produced by a sublimation laser at the tip of the dome 3′.

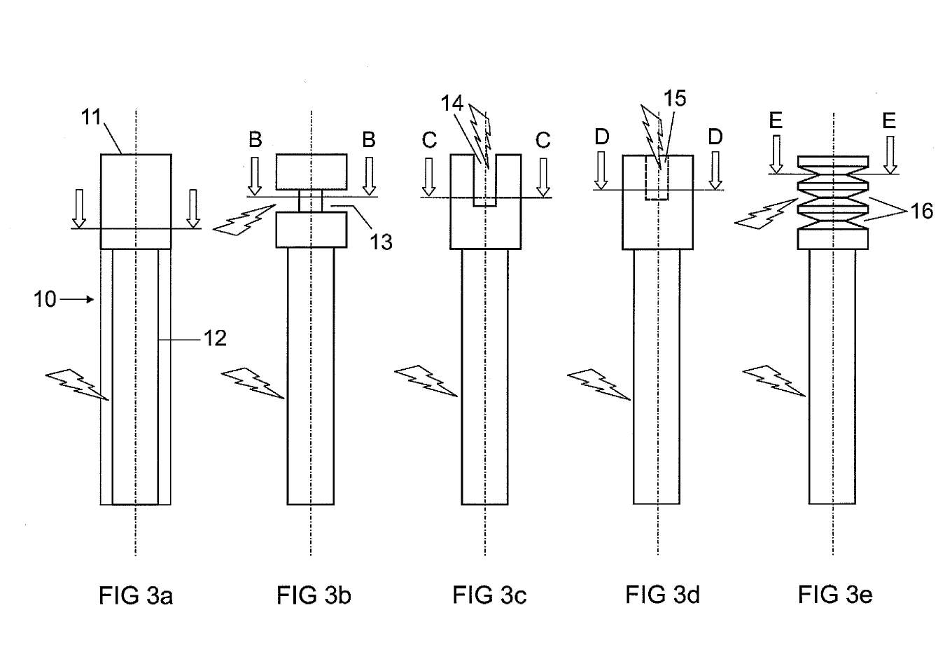

FIG. 3 illustrates the shaping for an electrode 10 with a cylindrical head 11. In this case, too, the electrode is produced in one piece from a solid material. FIG. 3a shows how the shaft 12 is removed from an originally cylindrical rod using the sublimation laser. In this case, too, the sublimation laser can again be used for producing a circumferential flute 13 as shown in FIG. 3b. As shown in FIG. 3c, a transverse slot 14 can also be produced in the head. As shown in FIG. 3d, a central bore 15 can be produced in the head. In particular, the sublimation laser can also be used for providing the head with a plurality of grooves 16, see FIG. 3e.

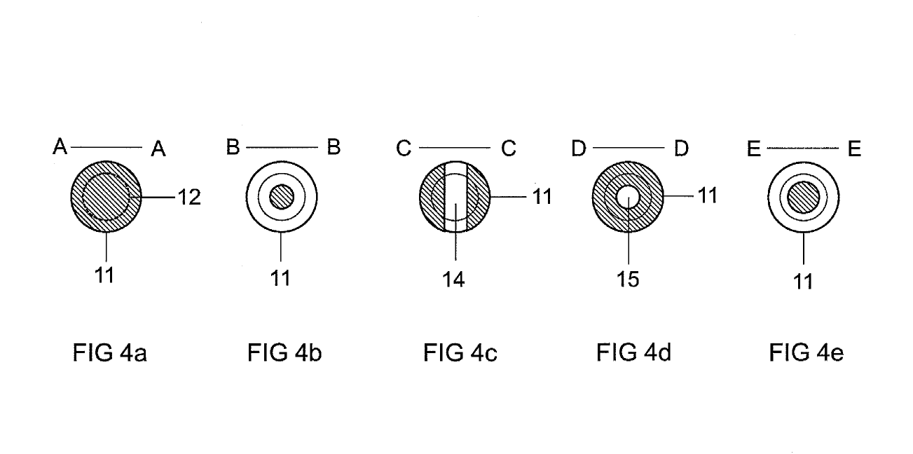

FIGS. 4a to 4e show the associated cross sections A-A to E-E through the electrodes shown in FIG. 3.

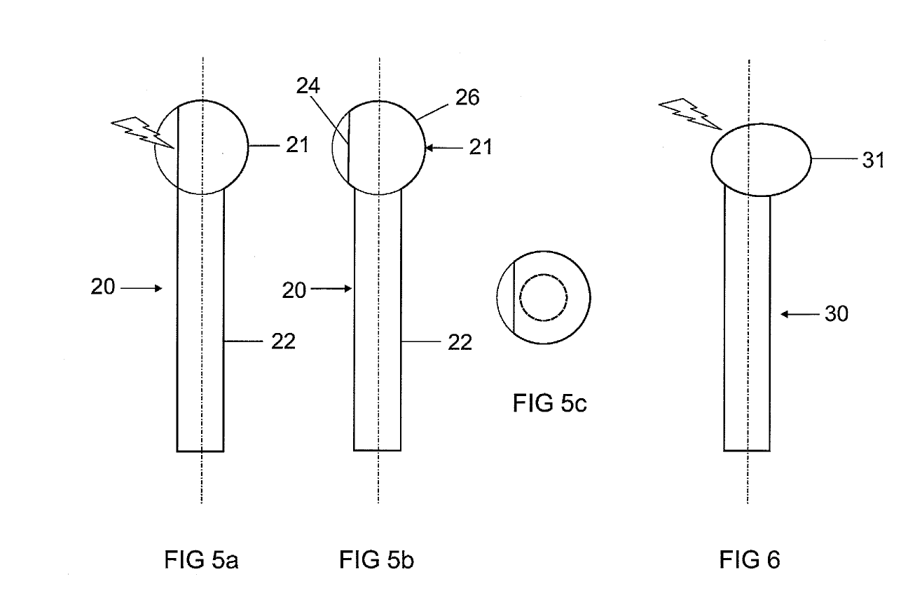

FIG. 5 shows a solid spherical-head electrode 20, which has initially been produced as in FIG. 1. Then, however, flank removal on one side is also carried out by a sublimation laser, with the result that the spherical head 21 either only now protrudes on one side beyond the shaft 22, see FIG. 5a, or protrudes to a lesser extent on one side 24 than on the other side 26, see FIG. 5b.

FIG. 6 shows an electrode 30 which has been produced in one piece from a rod as shown in FIG. 1. In this case, after shaping of the spherical head, additional shaping is achieved asymmetrically, namely the head 31 in the form of an ellipsoid or the like, by a sublimation laser subsequently processing the head 31, in particular by means of laser blasting, and/or by the tungsten pin being positioned beneath the sublimation laser during shaping of the head.

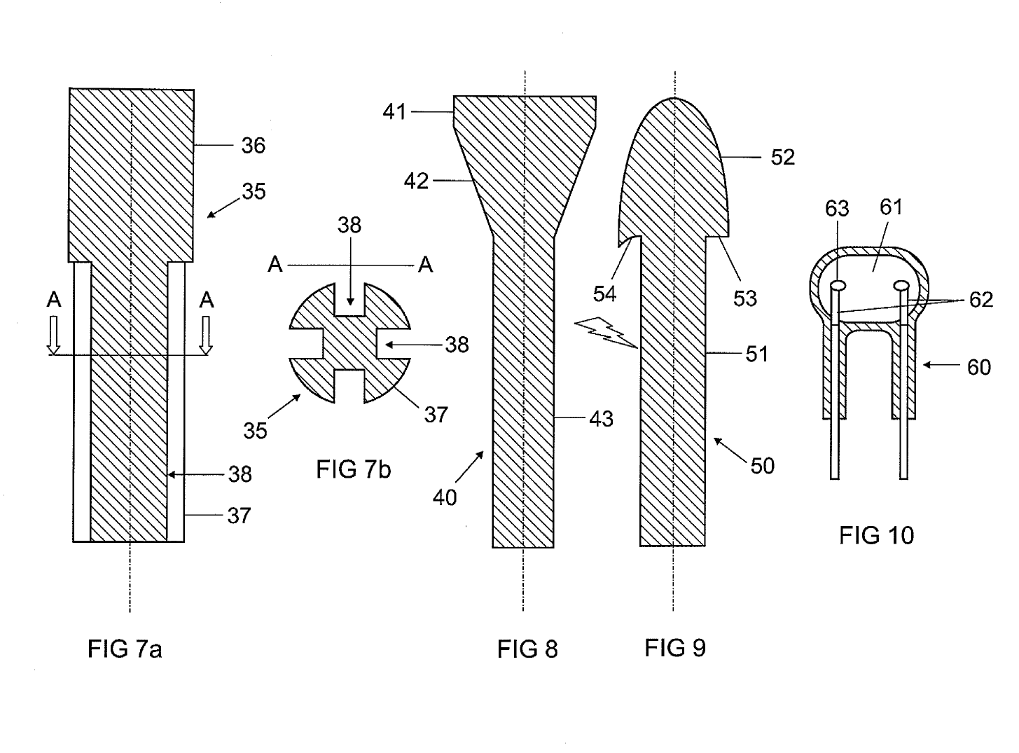

FIG. 7 shows a solid integral pin electrode 35 consisting of tungsten. It is manufactured from a W pin or rod with an originally constant diameter. In this case, the original diameter of the pin is retained at the head 36 in the form of a cylindrical head, but material is removed by grooves 38 in the region of the shaft 37, see FIG. 7a. Four grooves 38 are cut out in the shaft in longitudinally parallel fashion, with the result that the thermal capacity of said shaft is reduced. FIG. 7b shows a cross section through the shaft 37.

FIG. 8 shows a conical-head electrode 40 similar to that described in DE 202006004567. Said conical-head electrode is worked from a solid, integral rod. The original diameter of the rod is maintained at the head 41. The head tapers in the form of a segment of a cone 42 in the direction of the shaft 43. The diameter of the actual shaft 43 is markedly smaller than the maximum diameter of the head 41. The removal of material can also take place in this case according to the invention at best with the aid of a sublimation laser. Until now, only the possibility of milling has been known. The advantage of processing by means of a sublimation laser is that the surfaces can be cut more cleanly, that the electrode can be processed without any contact, and the shaping can be realized much more precisely. This advantage is provided over thermal processes of all types and over mechanical and chemical processes.

FIG. 9 shows an electrode 50, which can likewise be produced again from the blank shown in FIG. 1 by further-processing. In this case, the shaft 51 is cylindrical, and the head 52 has the configuration of a mushroom cap. In cross section, the contour of the head can be described as being in the form of a parabola. The edge of the cap 53 can be cut away straight or can be curved, as illustrated.

FIG. 10 shows a discharge vessel 60 which is sealed at one end for a high-pressure discharge lamp. It is preferably made from ceramic. Two electrodes 62, which are positioned asymmetrically with respect to one another, extend into the inner volume 61, in a similar manner to that described in FIG. 5. Such electrodes previously needed to be assembled mechanically in a complex manner or to be milled from one block, see DE-A 36 40 990. With the novel, contactless method by means of a sublimation laser, a large number of three-dimensional shapes can be worked in a precise manner. In this case, the head 63 of the electrode has at least approximately the configuration of an ellipsoid, whose thermal capacity is optimized with respect to requirements.

A method for producing an electrode by means of a laser uses the following steps:
providing a cylindrical rod or pin consisting of a high-melting material, in particular tungsten, alloys with tungsten or TaC;
making one end of the rod into a sphere by means of laser bombardment as is known per se;
subsequent processing of the solid integral electrode produced in this way by means of a sublimation laser.

The spherical shape is formed in a similar manner to that described in principle in DE-A 42 03 975.

1. An electrode for a high-pressure discharge lamp, cut out in one piece from a rod or pin, the electrode comprising:
an electrode head as first segment and
a shaft as second segment,
wherein the electrode has an asymmetrical shape which has been produced by means of a sublimation laser.

2. The electrode as claimed in claim 1, wherein the head is configured in the form of a dome, with side wall faces of the head having been removed.

3. The electrode as claimed in claim 1, wherein a segment of a sphere has been removed parallel to the longitudinal axis of the shaft, the cutting edge of the segment of the sphere in particular coinciding with an extension of a shaft edge.

4. The electrode as claimed in claim 1, wherein the head is shaped in the form of an ellipsoid or oval.

5. The electrode as claimed in claim 1, wherein the shaft of the electrode has been provided with longitudinally parallel grooves in pillar fashion.

6. The electrode as claimed in claim 1, wherein the head of the electrode is shaped in the form of a mushroom cap.

7. A discharge vessel for a high-pressure discharge lamp, the discharge vessel comprising:
at least one electrode, comprising:
an electrode head as first segment; and
a shaft as second segment,
wherein the electrode has an asymmetrical shape which has been produced
by means of a sublimation laser.

8. The discharge vessel as claimed in claim 7, wherein the discharge vessel is manufactured from a ceramic material, and is sealed at one end.

9. A high-pressure discharge lamp comprising a discharge vessel, the discharge vessel comprising:
at least one electrode, comprising:
an electrode head as first segment; and
a shaft as second segment,
wherein the electrode has an asymmetrical shape which has been produced
by means of a sublimation laser.

10. A method for producing an electrode by means of a laser, the method comprising:
providing a cylindrical rod or pin consisting of a high-melting;
making one end of the rod into a sphere by means of laser bombardment; and
subsequent processing of the solid integral electrode produced in this way by means of a sublimation laser.

11. The electrode as claimed in claim 6,
wherein the head of the electrode is shaped in the form of a mushroom cap,
wherein its cross section is a parabola segment.

12. The discharge vessel as claimed in claim 8,
wherein the discharge vessel is manufactured from Al₂O₃.

13. The method as claimed in claim 10,
wherein providing a cylindrical rod or pin consisting of a high-melting material
comprises providing a cylindrical rod or pin consisting of a high-melting material
selected from a group consisting of tungsten; alloys with tungsten; and TaC.
